(19) United States
(12) Patent Application Publication
(10) Pub. No.: US 2010/0136952 A1
(43) Pub. Date: Jun. 3, 2010

(54) MOBILE COMMUNICATION DEVICE WITH VIDEO APPLICATION FOR DISPLAY ON A REMOTE MONITOR AND METHODS FOR USE THEREWITH

(75) Inventor: Ahmadreza (Reza) Rofougaran, Newport Coast, CA (US)

Correspondence Address: GARLICK HARRISON & MARKISON, P.O. BOX 160727, AUSTIN, TX, 78716-0727, US

(73) Assignee: Broadcom Corporation, Irvine, CA (US)

(21) Appl. No.: 12/326,294

(22) Filed: Dec. 2, 2008

(51) Int. Cl. H04W 4/00

(52) U.S. Cl. 455/414.1

(57) ABSTRACT

A mobile communication device includes a processing module that executes a video application and that generates display data in response thereto. At least one transceiver sends the display data to a display device in a video mode of operation and transceives wireless telephony data with a wireless telephony network in a telephony mode of operation.

### CROSS-REFERENCE TO RELATED APPLICATIONS

Not applicable

### BACKGROUND OF THE INVENTION

### Technical Field of the Invention

### Description of Related Art

This invention relates generally to wireless systems and more particularly to wireless telephony devices.

### Description of Related Art

Communication systems are known to support wireless and wire lined communications between wireless and/or wire lined communication devices. Such communication systems range from national and/or international cellular telephone systems to the Internet to point-to-point in-home wireless networks to radio frequency identification (RFID) systems. Each type of communication system is constructed, and hence operates, in accordance with one or more communication standards. For instance, radio frequency (RF) wireless communication systems may operate in accordance with one or more standards including, but not limited to, RFID, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof. As another example, infrared (IR) communication systems may operate in accordance with one or more standards including, but not limited to, IrDA (Infrared Data Association).

Depending on the type of RF wireless communication system, a wireless communication device, such as a cellular telephone, two-way radio, personal digital assistant (PDA), personal computer (PC), laptop computer, home entertainment equipment, RFID reader, RFID tag, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each RF wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). As is known, the receiver is coupled to the antenna and includes a low noise amplifier, one or more intermediate frequency stages, a filtering stage, and a data recovery stage. The low noise amplifier receives inbound RF signals via the antenna and amplifies then. The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

As is also known, the transmitter includes a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

In most applications, radio transceivers are implemented in one or more integrated circuits (ICs), which are inter-coupled via traces on a printed circuit board (PCB). The radio transceivers operate within licensed or unlicensed frequency spectrums. For example, wireless local area network (WLAN) transceivers communicate data within the unlicensed Industrial, Scientific, and Medical (ISM) frequency spectrum of 900 MHz, 2.4 GHz, and 5 GHz. While the ISM frequency spectrum is unlicensed there are restrictions on power, modulation techniques, and antenna gain.

Many wireless communication devices include a display, such as a color liquid crystal display for displaying menus, navigational information, image data and video data that is either downloaded to the device or streamed from a video source such as a video server via the internet or streamed to the device from the service provider. The display is small and has limited resolution compared with monitors and television sets used for typical home viewing.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of an embodiment of a communication system in accordance with the present invention;

FIG. 2 is a schematic block diagram of an embodiment of another communication system in accordance with the present invention;

FIG. 3 presents a pictorial block diagram representation of a communication device 117 in accordance with an embodiment of the present invention;

FIG. 4 presents a pictorial representation of a communication device 117 and display device 806 in accordance with an embodiment of the present invention;

FIG. 5 is a schematic block diagram of an embodiment of a communication device 117 in accordance with the present invention;

FIG. 6 is a schematic block diagram of another embodiment of a communication device 117′ in accordance with the present invention;

FIG. 7 is a schematic block diagram of another embodiment of a communication device 117″ in accordance with the present invention;

FIG. 8 is a schematic block diagram of another embodiment of a communication device 117′″ in accordance with the present invention;

FIG. 9 is a schematic block diagram of an RF transceiver 135 in accordance with an embodiment of the present invention;

FIG. 10 is a schematic block diagram of an RF receiver 137′ in accordance with an embodiment of the present invention;

FIG. 11 presents a pictorial block diagram representation of a communication device 117 in accordance with another embodiment of the present invention;

FIG. 12 is a flowchart representation of a method in accordance with an embodiment of the present invention; and

FIG. 13 is a flowchart representation of a method in accordance with an embodiment of the present invention.

### DETAILED DESCRIPTION OF THE INVENTION

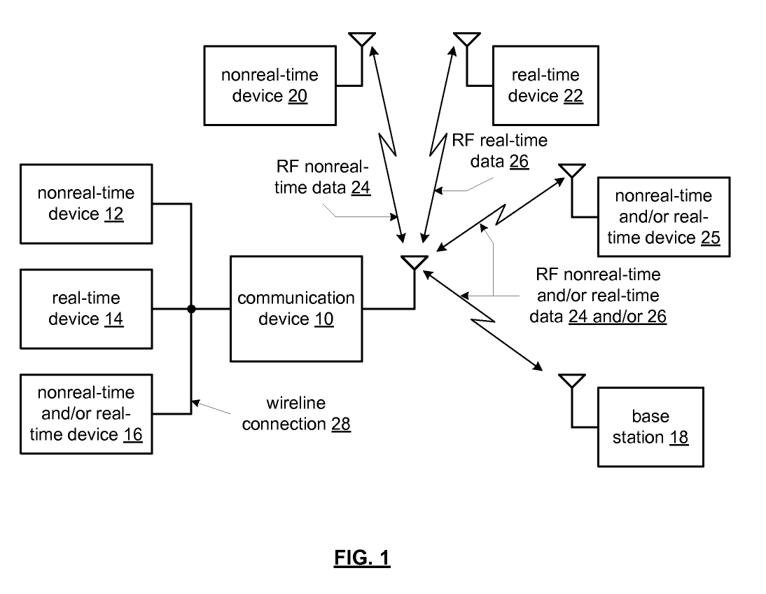

FIG. 1 is a schematic block diagram of an embodiment of a communication system in accordance with the present invention. In particular, a communication system is shown that includes a communication device 10 that communicates real-time data 24 and non-real-time data 26 wirelessly with one or more other devices such as base station 18, non-real-time device 20, real-time device 22, and non-real-time and/or real-time device 25. In addition, communication device 10 can also optionally communicate over a wireline connection with non-real-time device 12, real-time device 14 and non-real-time and/or real-time device 16.

In an embodiment of the present invention the wireline connection 28 can be a wired connection that operates in accordance with one or more standard protocols, such as a universal serial bus (USB), Institute of Electrical and Electronics Engineers (IEEE) 488, IEEE 1394 (Firewire), Ethernet, small computer system interface (SCSI), serial or parallel advanced technology attachment (SATA or PATA), or other wired communication protocol, either standard or proprietary. The wireless connection can communicate in accordance with a wireless network protocol such as IEEE 802.11, Bluetooth, Ultra-Wideband (UWB), WIMAX, or other wireless network protocol, a wireless telephony data/voice protocol such as Global System for Mobile Communications (GSM), General Packet Radio Service (GPRS), Enhanced Data Rates for Global Evolution (EDGE), Personal Communication Services (PCS), or other mobile wireless protocol, RFID of other RF tag protocol or other wireless communication protocol, either standard or proprietary. Further, the wireless communication path can include separate transmit and receive paths that use separate carrier frequencies and/or separate frequency channels. Alternatively, a single frequency or frequency channel can be used to bi-directionally communicate data to and from the communication device 10.

Communication device 10 can be a mobile phone such as a cellular telephone, a personal digital assistant, game device, personal computer, laptop computer, or other device that performs one or more functions that include communication of voice and/or data via wireline connection 28 and/or the wireless communication path. In an embodiment of the present invention, the real-time and non-real-time devices 12, 14 16, 18, 20, 22 and 25 can be a game console, access points, personal computers, laptops, PDAs, mobile phones, such as cellular telephones, devices equipped with wireless local area network or Bluetooth transceivers, FM tuners, TV tuners, digital cameras, digital camcorders, or other devices that either produce, process or use audio, video signals or other data or communications.

In operation, the communication device includes one or more applications that include voice communications such as standard telephony applications, voice-over-Internet Protocol (VoIP) applications, local gaming, Internet gaming, email, instant messaging, multimedia messaging, web browsing, audio/video recording, audio/video playback, audio/video downloading, playing of streaming audio/video, office applications such as databases, spreadsheets, word processing, presentation creation and processing and other voice and data applications. In conjunction with these applications, the real-time data 26 includes telephony data, voice, audio, video, multimedia data, display data, motion data, for application such as telephony, gaming, or other applications. The non-real-time data 24 includes text messaging, email, web browsing, file uploading and downloading, authentication data, user preferences, and other data used in any of the application discussed above.

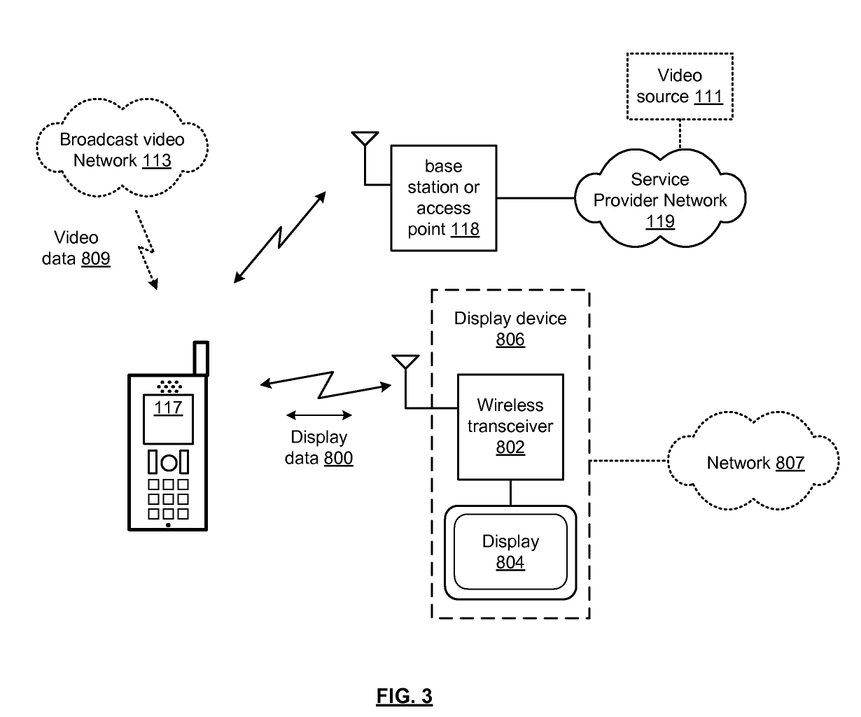

In an embodiment of the present invention, the communication device 10 includes an integrated circuit, such as an RF integrated circuit that includes one or more features or functions of the present invention. Such features and functions shall be described in greater detail in association with FIGS. 3-13 that follow.

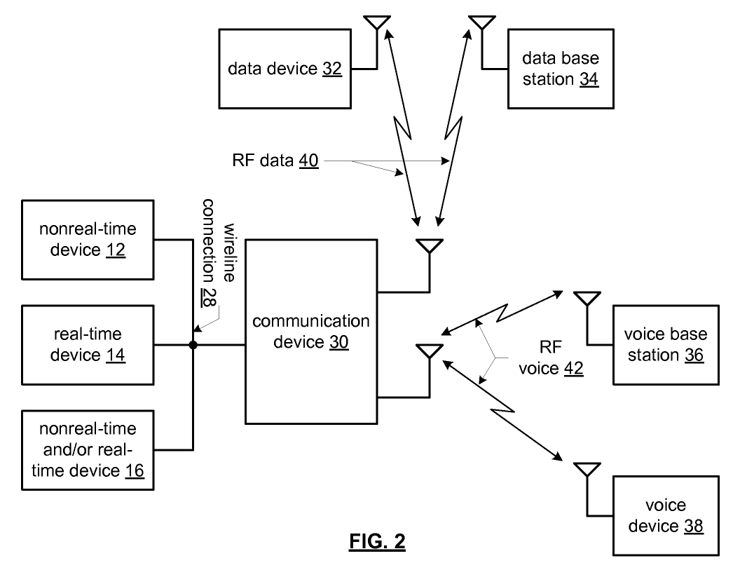

FIG. 2 is a schematic block diagram of an embodiment of another communication system in accordance with the present invention. In particular, FIG. 2 presents a communication system that includes many common elements of FIG. 1 that are referred to by common reference numerals. Communication device 30 is similar to communication device 10 and is capable of any of the applications, functions and features attributed to communication device 10, as discussed in conjunction with FIG. 1. However, communication device 30 includes one or more separate wireless transceivers for communicating, contemporaneously, via two or more wireless communication protocols with data device 32 and/or data base station 34 via RF data 40 and voice base station 36 and/or voice device 38 via RF voice signals 42.

FIG. 3 presents a pictorial block diagram representation of a communication device 117 in accordance with an embodiment of the present invention. Communication device 117, such as communication device 10 or 30, is a wireless telephone device or other device that includes a wireless telephony transceiver and that, in a telephony mode of operation, is capable of placing a receiving conventional wireless telephone calls, voice over internet protocol telephone calls, communicating via a wireless telephony protocol such as cellular voice or data protocol such as GSM, GPRS, AMPS, UMTS, EDGE, 802.11a,b,g,n or other wireless telephony or data protocol that can be used to communicate with a service provider network 119 via base station or access point 118. The service provider network 119 can be a wireless telephone or data network, the Internet or other network. In this fashion, a user can operate communication device 117 as a wireless telephone to place and receive telephone calls, surf the Web or download ringtones, etc. In an embodiment of the present invention, communication device 117 optionally includes a GPS receiver and generates position information that is used by communication device 117 and/or a network for location-based services, GPS navigation applications, and for placing emergency calls such as 911 (e911) calls.

In addition, communication device 117 can be a dual mode or multi-mode device that can be used in a video mode of operation. In this mode, communication device 117 includes a processor that executes a video player application based on video data and that generates display data 800 in response thereto. Video data can include video files that are stored to a memory of the communication device 117 when coupled to a computer or other host device via a wireless or wireline connection, such as wireline connection 28 or downloaded to the communication device 117 from a video source 111 such as an Internet video server that is coupled to service provider network 119 or other video content downloadable from service provider network 119. In this fashion, the user of communication device 117 can launch the video player application to watch stored movies, television shows, podcasts, educational content and other video content. Video data can also be streaming video data accessed from a video source 111 or received directly as a video signal 809 from a broadcast video network 113 via digital UHF broadcasting, DVBH transmission or other broadcast video transmissions.

In operation, the user interface of the communication device 117 allows the user to select and control the playback of the video content, and further to enter authentication data, preferences data, and/or other data associated with a user's access to video data from remote sources and the operation of the video player application. The video player application, in turn, decodes the video data and generates display data 800 for transmission to a remote display device 806 and optionally for concurrent display on its own integrated display device.

A transceiver included in communication device 117, such as a wireless telephony transceiver, millimeter wave tranceiver or other transceiver, sends the display data 800 to a display device 806 via an RF signal. The display device 806 is equipped with a compatible wireless transceiver or receiver 802 for receiving the display data 800 and presenting the display data to display 804. In an embodiment of the present invention, the display data 800 is a stream of digital video data formatted in accordance with an uncompressed digital video format such as High-Definition Multimedia Interface (HDMI), display data generated by digitizing an analog video format such as VGA, s-video or other analog video format, a compressed digital video format such as analog video format Motion Picture Expert Group (MPEG) standard such as MPEG2 or MPEG4, formatted in accordance with another standard such as H.264, or formatted in accordance with another digital format.

The display device 806 can be a home display device, such as a home computer, monitor, television or other display device that is equipped with or coupled to a wireless transceiver 802 or other device. Display 804 can include a cathode ray tube (CRT), liquid crystal display (LCD), plasma display, projection screen or other display along with an digital to analog converter or other interface face device for generating a video display based on the received display data 800. In this fashion, a user of communication device 117 can watch video content being played by a video player application of communication device 117 on a larger screen than the small screen integrated in communication device 117. In addition, in an embodiment of the present invention, the user interface of the communication device 117 including the integrated display can be used to control the playback of the video content via the video player application.

In another embodiment of the present invention, the display device 806 includes a public display device such as a publicly accessible monitor television, display kiosk or other public display device. In operation, the communication device 117, via its processing module, generates connection data for establishing a connection with the public display device. The connection data can include subscription data, such as a device identifier, user password, user ID, encryption key or other subscription and/or authentication data associated with either the communication device 117, or a user of the communication device. In this fashion, the user can access public devices included in a subscription plan or access a public device on a pay-per use basis with billing being processed in accordance with the subscription information. Alternatively, the connection data can include payment data, such as credit card information or other billing information to effectuate access to the public display device on a pay-per-use basis. Display device 806 is optionally connected via a modem, network card or other interface, to network 807 such as the Internet or other data network. In this fashion, display device 806 can verify subscription information, payment information such as via a credit or debit card of the user or other authentication data, and provide other services, such as video, data and gaming services to display device 806 when not in communication with communication device 117.

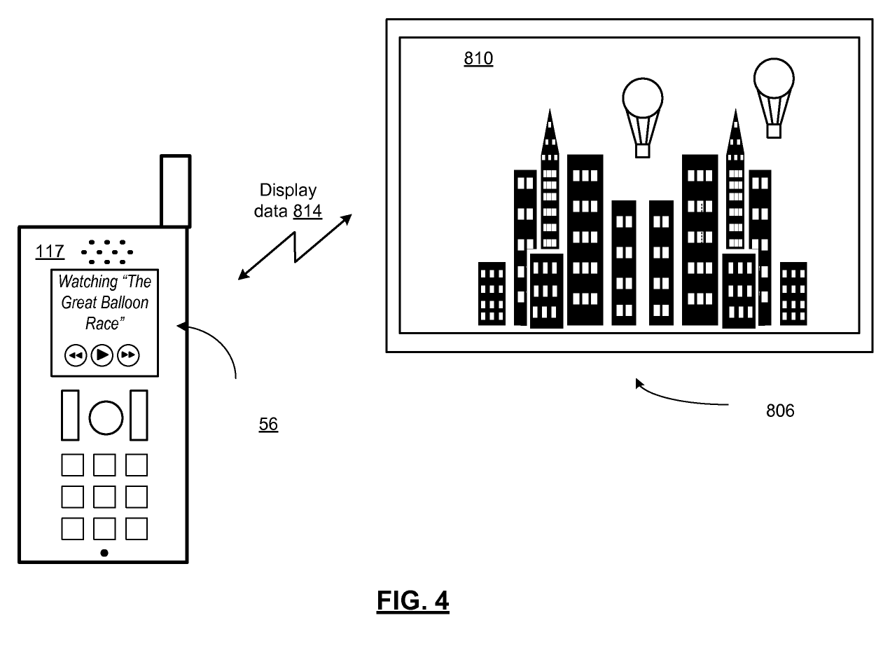

FIG. 4 presents a pictorial representation of a communication device 117 and display device 806 in accordance with an embodiment of the present invention. In particular, display screen 810 of display device 806 is shown in conjunction with communication device 117. In this embodiment, the user of communication device 117 has launched a video application and selected the playback of a stored digital video file of the feature film, “The Great Balloon Race”.

Communication device 117 generates first display data for its integrated display 56 as part of a user interface that provides user control over the selection and playback of the feature film. In this fashion, the user can, for instance, play, rewind, and fastforward and optionally pause and stop the playback of the film. In addition, communication device 117 also generates display data 814, such as display data 800 in a HDMI format, that is wirelessly transmitted to display device 806. In response to the received display data 814, display device 806 generates the screen display 810 to show the film.

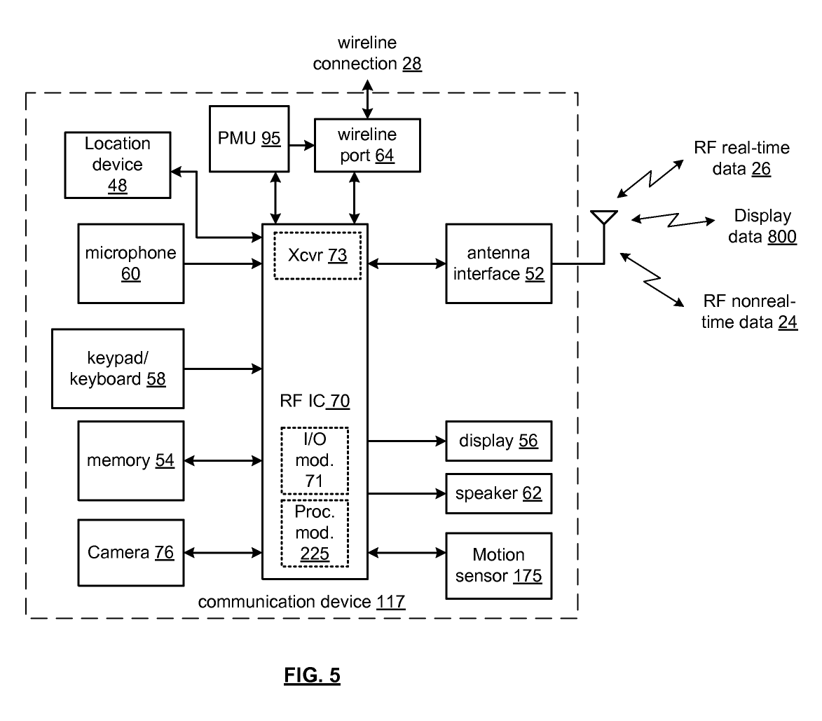

FIG. 5 is a schematic block diagram of an embodiment of a communication device 117 in accordance with the present invention. In particular, an RF integrated circuit (IC) 70 is shown that implements communication device 117 in conjunction with location device 48, microphone 60, keypad/keyboard 58, memory 54, speaker 62, display 56, camera 76, antenna interface 52 and wireline port 64 In this embodiment of the present invention, the transceiver 73 can operate in a telephony mode where the real-time data 26 and/or non-real-time data 24 include telephony data communicated with a telephony network. As previously discussed, transceiver 73 can receive video data from a remote video source such as video source 111 as either a digital video file or as a streaming video signal. Transceiver 73 can further operate and in a video mode of operation where display data, such as display data 800, is transmitted to a remote display device. The antenna can be a fixed antenna, a single-input single-output (SISO) antenna, a multi-input multi-output (MIMO) antenna, a diversity antenna system, an antenna array or other antenna configuration that optionally allows the beam shape, gain, polarization or other antenna parameters to be controlled.

In addition, RF IC 70 includes input/output module 71 that includes the appropriate interfaces, drivers, encoders and decoders for communicating via the wireline connection 28 via wireline port 64, an optional memory interface for communicating with off-chip memory 54, a codec for encoding voice signals from microphone 60 into digital voice signals, a keypad/keyboard interface for generating data from keypad/keyboard 58 in response to the actions of a user, a display driver for driving display 56, such as by rendering a color video signal, text, graphics, or other display data, and an audio driver such as an audio amplifier for driving speaker 62 and one or more other interfaces, such as for interfacing with the camera 76 or the other peripheral devices. When processing module 225 executes a gaming application, I/O module 71 can include a video generator for generating the display data 800 that can be implemented in dedicated hardware such as a video processor or other circuit such as included in processor 225.

In operation, communication device 117 can generate user interface data in response to a user's interaction with microphone 60, actuator 48, keypad/keyboard 58, to provide commands and preferences, user selections, authentication data, control data or other data associated with a user's selection, access to, set-up, and operation of the telephony mode of operation, the video mode of operation and optionally in conjunction with other operational modes.

Power management circuit (PMU) 95 includes one or more DC-DC converters, voltage regulators, current regulators or other power supplies for supplying the RF IC 70 and optionally the other components of communication device 10 and/or its peripheral devices with supply voltages and or currents (collectively power supply signals) that may be required to power these devices. Power management circuit 95 can operate from one or more batteries, line power, an inductive power received from a remote device, a piezoelectric source that generates power in response to motion of the integrated circuit and/or from other power sources, not shown. In particular, power management module can selectively supply power supply signals of different voltages, currents or current limits or with adjustable voltages, currents or current limits in response to power mode signals received from the RF IC 70. While shown as an off-chip module, PMU 95 can alternatively implemented as an on-chip circuit.

In addition, RF IC 70 and is coupled to a motion sensor 175 that generates motion data in response to motion of the communication device 117. Motion sensor 175 can be implemented via one or more one, two or three-axis accelerometers or one or more on-chip gyrating circuits implemented with microelectromechanical systems (MEMS) technology to form a piezoelectric gyroscope, a vibrating wheel gyroscope, a tuning fork gyroscope, a hemispherical resonator gyroscope, or a rotating wheel gyroscope that responds to inertial forces, such as Coriolis acceleration or linear acceleration, in one, two or three axes to generate motion data, such as a velocity vector in one, two or three dimensions and/or one, two or three orientations. Motion data can be used as user interface data in support of the telephony and video modes of operation. The location device 48 can include a GPS receiver that generates GPS position data that can be used in the telephony mode of operation and/or in conjunction with a navigation system application in a navigation mode of operation. While motion sensor 175 and location device 48 are shown as a off-chip components, either of these units can be implemented either on-chip or off-chip, depending on the implementation.

In an embodiment of the present invention, the RF IC 70 is a system on a chip integrated circuit that includes at least one processing device. Such a processing device, for instance, processing module 225, may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices that are either on-chip or off-chip such as memory 54. Such a memory device may be a read-only memory, random access memory, volatile memory, non-volatile memory, static memory, dynamic memory, flash memory, and/or any device that stores digital information. Note that when the RF IC 70 implements one or more of its functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry. Transceiver 73, and I/O module 71 can be implemented via stand alone hardware, or software and/or firmware operating in conjunction with processing module 225.

In further operation, the RF IC 70 executes operational instructions that implement one or more of the applications (real-time or non-real-time) attributed to communication device 117 as discussed above and in conjunction with FIGS. 1-4.

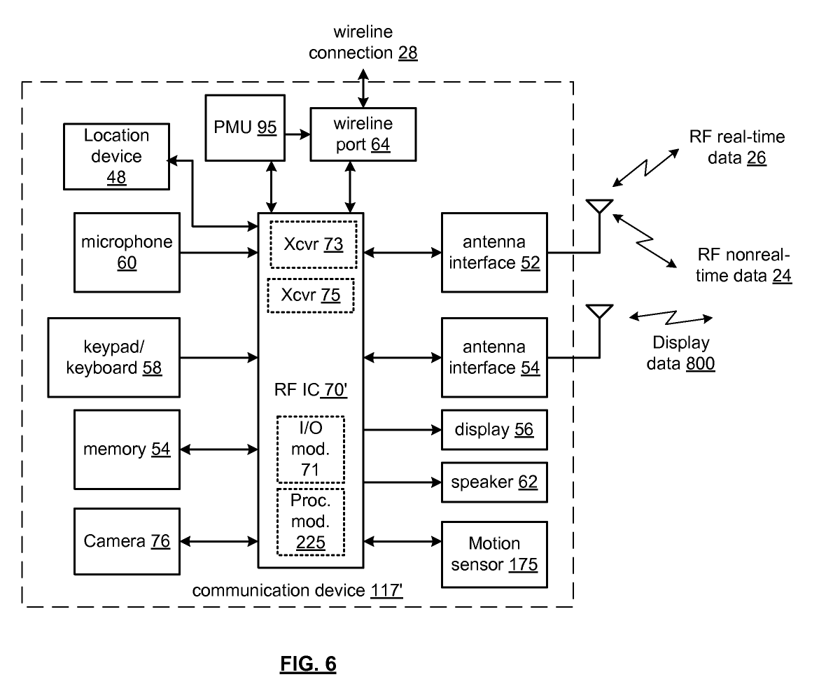

FIG. 6 is a schematic block diagram of another embodiment of a communication device 117′ in accordance with the present invention. In particular a communication device 117′ is shown that is similar to communication device 117. Similar elements are referred to by common reference numerals. In this embodiment however, RF IC 70′ includes a dedicated transceiver 75 and antenna interface 54 for communicating display data 800. Transceiver 75 is a millimeter wave transceiver or other wireless transceiver that sends and/or receiver data via millimeter RF signals or other RF signals at other frequencies. Such millimeter wave RF signals can be in a 60 GHz band or other millimeter wave frequency band. As in RF IC 70, transceiver 73 operates as a wireless telephony transceiver in accordance with a cellular voice or data protocol such as GSM, GPRS, AMPS, UMTS, EDGE, 802.11a,b,g,n or other wireless telephony or data protocol. Transceiver 75 sends the display data 800 to the display device 806 in the video mode of operation, and further communicates connection data or other data between communication device 117′ and display device 806 in conjunction with the connection, set-up and playing of one or more segments of video content.

FIG. 7 is a schematic block diagram of another embodiment of a communication device 117″ in accordance with the present invention. In particular a communication device 117″ is shown that is similar to communication device 117. Similar elements are referred to by common reference numerals. As in RF IC 70, transceiver 73 operates as a wireless telephony transceiver in accordance with a cellular voice or data protocol such as GSM, GPRS, AMPS, UMTS, EDGE, 802.11a,b,g,n or other wireless telephony or data protocol and sends the display data 800 to the display device 806 in the video mode of operation, and further communicates connection data or other data between communication device 117″ and display device 806 in conjunction with the connection, set-up and playing of one or more segments of video content. In this embodiment however, RF IC 70″ includes a dedicated receiver 77 and antenna interface 55 for receiving video data 809 from a broadcast video source, such as broadcast video network 113. Receiver 77 can include a digital UHF receiver for receiving over the air digital television broadcasts, a DVBH (Digital video broadcast-handheld) receiver or receiver for receiving other video broadcasts from a broadcast video network.

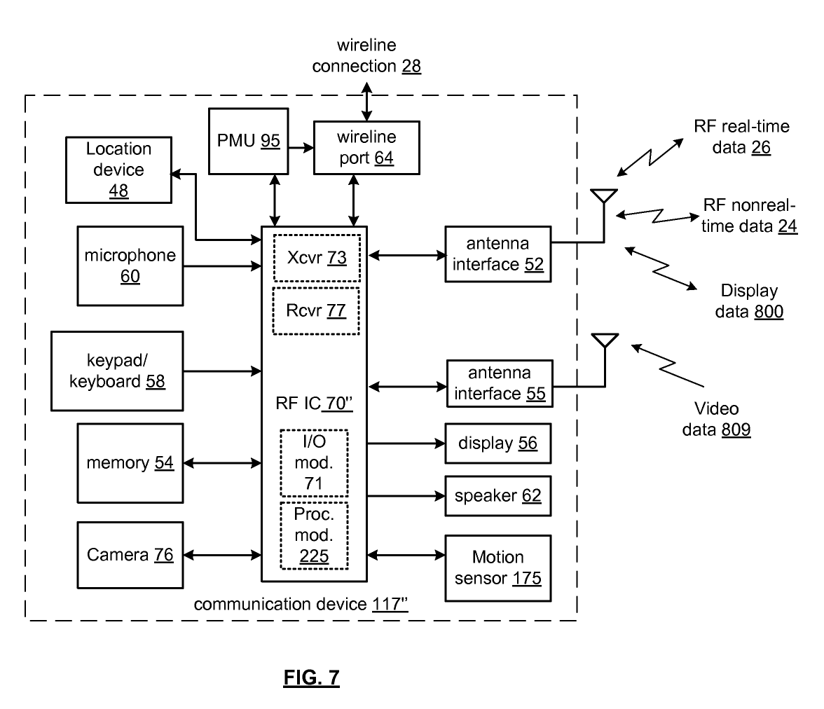

FIG. 8 is a schematic block diagram of another embodiment of a communication device 117′″ in accordance with the present invention. In particular a communication device 117′″ is shown that is similar to communication devices 117, 117′ and 117″. Similar elements are referred to by common reference numerals. As in RF IC 70, transceiver 73 operates as a wireless telephony transceiver in accordance with a cellular voice or data protocol such as GSM, GPRS, AMPS, UMTS, EDGE, 802.11a,b,g,n or other wireless telephony or data protocol. As in RFIC 70′ dedicated transceiver 75 sends the display data 800 to the display device 806 in the video mode of operation, and further communicates connection data or other data between communication device 117′″ and display device 806 in conjunction with the connection, set-up and playing of one or more segments of video content. As in RF IC 70″, a dedicated receiver 77 and antenna interface 55 are included for receiving video data 809 from a broadcast video source, such as broadcast video network 113.

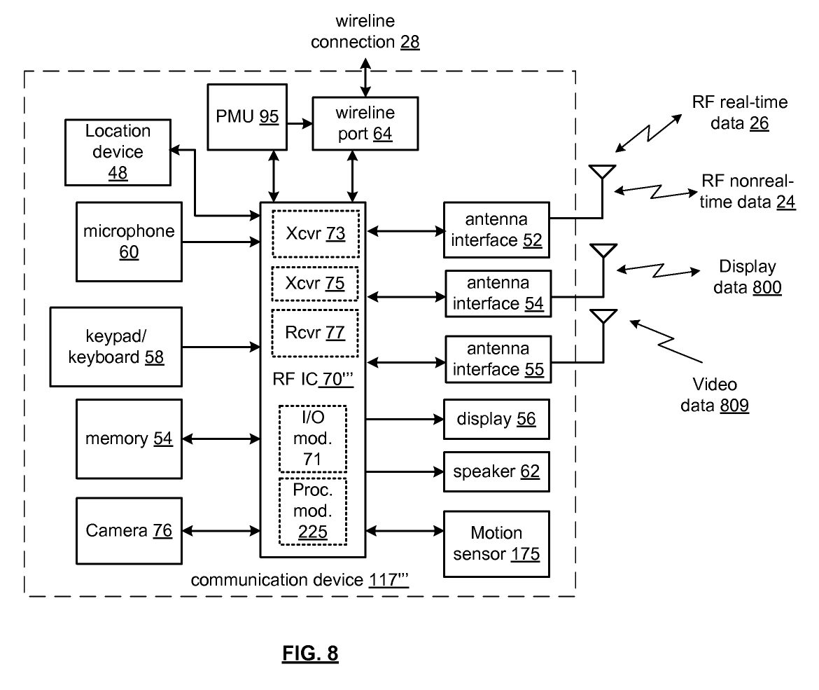

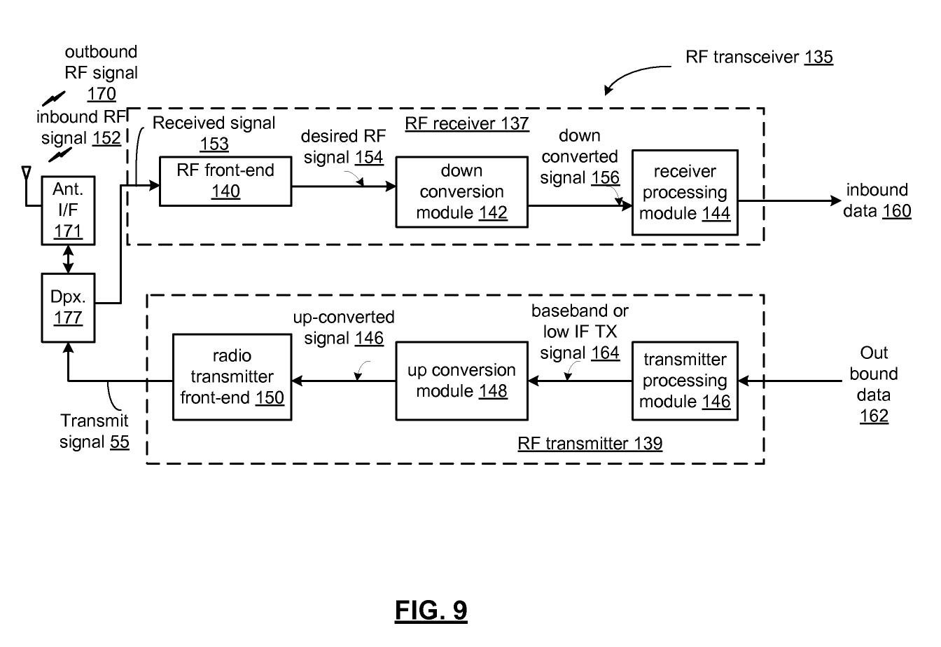

FIG. 9 is a schematic block diagram of an embodiment of RF transceiver 135 in accordance with the present invention. The RF transceiver 135, such as transceiver 73 or 75, includes an RF transmitter 139, and an RF receiver 137. The RF receiver 137 includes a RF front end 140, a down conversion module 142 and a receiver processing module 144. The RF transmitter 139 includes a transmitter processing module 146, an up conversion module 148, and a radio transmitter front-end 150.

As shown, the receiver and transmitter are each coupled to an antenna through an off-chip antenna interface 171 and a diplexer (duplexer) 177, that couples the transmit signal 155 to the antenna to produce outbound RF signal 170 and couples inbound signal 152 to produce received signal 153. Alternatively, a transmit/receive switch can be used in place of diplexer 177. While a single antenna is represented, the receiver and transmitter may share a multiple antenna structure that includes two or more antennas. In another embodiment, the receiver and transmitter may share a multiple input multiple output (MIMO) antenna structure, diversity antenna structure, phased array or other controllable antenna structure that includes a plurality of antennas. Each of these antennas may be fixed, programmable, and antenna array or other antenna configuration. Also, the antenna structure of the wireless transceiver may depend on the particular standard(s) to which the wireless transceiver is compliant and the applications thereof.

In operation, the transmitter receives outbound data 162 such as display data, connection data, real-time data 26, non real time data 24, etc. from a telephony application, video application or other application via the transmitter processing module 146. The transmitter processing module 146 packetizes outbound data 162 in accordance with a millimeter wave protocol or wireless telephony protocol, either standard or proprietary, to produce baseband or low intermediate frequency (IF) transmit (TX) signals 164 that includes an outbound symbol stream that contains outbound data 162. The baseband or low IF TX signals 164 may be digital baseband signals (e.g., have a zero IF) or digital low IF signals, where the low IF typically will be in a frequency range of one hundred kilohertz to a few megahertz. Note that the processing performed by the transmitter processing module 146 can include, but is not limited to, scrambling, encoding, puncturing, mapping, modulation, and/or digital baseband to IF conversion.

The up conversion module 148 includes a digital-to-analog conversion (DAC) module, a filtering and/or gain module, and a mixing section. The DAC module converts the baseband or low IF TX signals 164 from the digital domain to the analog domain. The filtering and/or gain module filters and/or adjusts the gain of the analog signals prior to providing it to the mixing section. The mixing section converts the analog baseband or low IF signals into up-converted signals 166 based on a transmitter local oscillation.

The radio transmitter front end 150 includes a power amplifier and may also include a transmit filter module. The power amplifier amplifies the up-converted signals 166 to produce outbound RF signals 170, which may be filtered by the transmitter filter module, if included. The antenna structure transmits the outbound RF signals 170 to a targeted device such as probe device 105 or devices 100 or 101 via an antenna interface 171 coupled to an antenna that provides impedance matching and optional bandpass filtration.

The receiver receives inbound RF signals 152 via the antenna and off-chip antenna interface 171 that operates to process the inbound RF signal 152 into received signal 153 for the receiver front-end 140. In general, antenna interface 171 provides impedance matching of antenna to the RF front-end 140, optional bandpass filtration of the inbound RF signal 152.

The down conversion module 142 includes a mixing section, an analog to digital conversion (ADC) module, and may also include a filtering and/or gain module. The mixing section converts the desired RF signal 154 into a down converted signal 156 that is based on a receiver local oscillation 158, such as an analog baseband or low IF signal. The ADC module converts the analog baseband or low IF signal into a digital baseband or low IF signal. The filtering and/or gain module high pass and/or low pass filters the digital baseband or low IF signal to produce a baseband or low IF signal 156 that includes a inbound symbol stream. Note that the ordering of the ADC module and filtering and/or gain module may be switched, such that the filtering and/or gain module is an analog module.

The receiver processing module 144 processes the baseband or low IF signal 156 in accordance with a millimeter wave protocol, either standard or proprietary to produce inbound data 160 such as display data, connection data, real-time data 26, non real time data 24, etc. from a real time device 22, nonrealtime device 20, access point or base station 18, display device 806, etc. The processing performed by the receiver processing module 144 can include, but is not limited to, digital intermediate frequency to baseband conversion, demodulation, demapping, depuncturing, decoding, and/or descrambling.

In an embodiment of the present invention, receiver processing module 144 and transmitter processing module 146 can be implemented via use of a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices that are either on-chip or off-chip. Such a memory device may be a read-only memory, random access memory, volatile memory, non-volatile memory, static memory, dynamic memory, flash memory, and/or any device that stores digital information. Note that when the processing devices implement one or more of their functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry.

While the processing module 144 and transmitter processing module 146 are shown separately, it should be understood that these elements could be implemented separately, together through the operation of one or more shared processing devices or in combination of separate and shared processing.

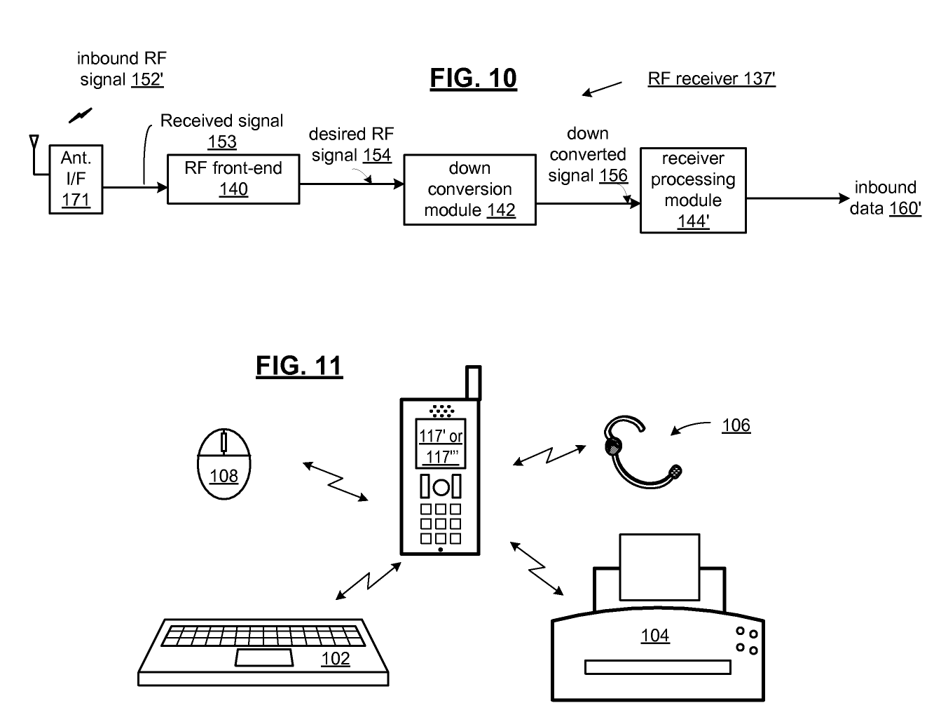

FIG. 10 is a schematic block diagram of an RF receiver 137′ in accordance with an embodiment of the present invention. In particular, a receiver 137′ is shown, such as receiver 77, that includes many similar elements to receiver 137 that are referred to by common reference numerals. Receiver 137′ is a digital UHF receiver for receiving over the air digital television broadcasts, a DVBH (Digital video broadcast-handheld) receiver or other receiver for receiving other video broadcasts from a broadcast video network, such as broadcast video network 113. In operation, receiver 137′ receives a broadcast video signal from the broadcast video network and generates inbound data 162′ that can include video data, such as video data 809.

FIG. 11 presents a pictorial block diagram representation of a communication device 117′ or 117′″ in accordance with another embodiment of the present invention. In these embodiments, the transceiver 75 can further be used for communication of peripheral data with one or more peripheral devices such as keyboard 102, printer 104, headset 106 and pointing device 108 equipped with a complementary transceiver. In this fashion, actions of the user of keyboard 102 and pointing device 108 can generate peripheral data such as user interface data for use in one or more applications executed by communication device 117′ or 117′″. Peripheral data in the form of data to be printed can be transmitted to printer 104. Voice data can be transceived with headset 106 in conjunction with hands free telephone calls, audio and video applications, etc. In an embodiment of the present invention, audio programming associated with the playback of video data can be transmitted to headset 106 for private listening of a video content displayed on display device 806.

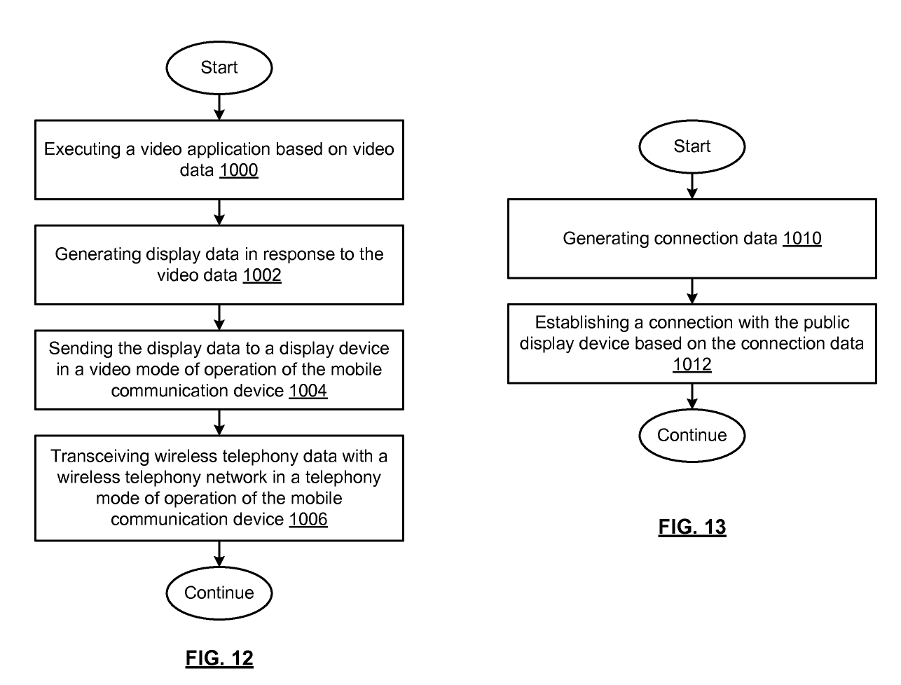

FIG. 12 is a flowchart representation of a method in accordance with an embodiment of the present invention. In particular, a method is presented for use in conjunction with one or more of the functions and features described in conjunction with FIGS. 1-11. In step 1000, a video application is executed based on video data. In step 1002, display data is generated in response to the video data. In step 1004, the display data is sent to a display device in a video mode of operation of the mobile communication device. In step 1004, wireless telephony data is transceived with a wireless telephony network in a telephony mode of operation of the mobile communication device. In an embodiment of the present invention, the display device includes a home display device. The video data can includes a streaming video data signal, a digital video file, broadcast video data or other video data.

FIG. 13 is a flowchart representation of a method in accordance with an embodiment of the present invention. In particular, a method is presented for use in conjunction with one or more of the functions and features described in conjunction with FIGS. 1-12. In this embodiment, the display device includes a public display device, and the method includes step 1010 of generating connection data and step 1012 of establishing a connection with the public display device based on the connection data. The connection data can include subscription data associated with the mobile communication device and/or a user of the mobile communication device. The connection data can also include payment data.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A mobile communication device comprising:
a processor that executes a video application based on video data and that generates display data in response thereto; and
at least one transceiver, coupled to the processing module, that sends the display data to a display device in a video mode of operation and that transceives wireless telephony data with a wireless telephony network in a telephony mode of operation.

2. The mobile communication device of claim 1 wherein the display device includes a home display device.

3. The mobile communication device of claim 1 wherein the display device includes a public display device, and the processing module further generates connection data for establishing a connection with the public display device.

4. The mobile communication device of claim 4 wherein the connection data includes subscription data associated with at least one of: the mobile communication device, and a user of the mobile communication device.

5. The mobile communication device of claim 4 wherein the connection data includes payment data.

6. The mobile communication device of claim 1 wherein the at least one transceiver includes a wireless telephony transceiver that transceives wireless telephony data with the wireless telephony network in the telephony mode of operation.

7. The mobile communication device of claim 6 wherein the wireless telephony transceiver sends the display data to the display device in the video mode of operation.

8. The mobile communication device of claim 1 wherein the at least one transceiver includes a millimeter wave transceiver that sends the display data to the display device in the video mode of operation.

9. The mobile communication device of claim 8 wherein the millimeter wave transceiver further communicates peripheral data with at least one peripheral device.

10. The mobile communication device of claim 9 wherein the at least one peripheral device includes at least one of, a keyboard, a pointing device, and a printer.

11. The mobile communication device of claim 1 wherein the at least one transceiver includes a wireless receiver for receiving the video data from a remote video source.

12. The mobile communication device of claim 11 wherein the remote video source coupled to a public data network and wherein the video data includes at least one of: a streaming video data signal, and a digital video file.

13. The mobile communication device of claim 11 wherein the video data includes broadcast video data.

14. A method for use in a mobile communication device, the method comprising:
executing a video application based on video data;
generating display data in response to the video data;
sending the display data to a display device in a video mode of operation of the mobile communication device; and
transceiving wireless telephony data with a wireless telephony network in a telephony mode of operation of the mobile communication device.

15. The method of claim 14 wherein the display device includes a home display device.

16. The method of claim 14 wherein the display device includes a public display device, and the method further comprises:
generating connection data; and
establishing a connection with the public display device based on the connection data.

17. The method of claim 16 wherein the connection data includes subscription data associated with at least one of: the mobile communication device, and a user of the mobile communication device.

18. The method of claim 16 wherein the connection data includes payment data.

19. The method of claim 14 wherein the video data includes at least one of: a streaming video data signal, and a digital video file.

20. The method of claim 14 wherein the video data includes broadcast video data.
